(19) United States
(12) Patent Application Publication
(10) Pub. No.: US 2022/0202013 A1
(43) Pub. Date: Jun. 30, 2022

(54) A Stable Insecticide Composition

(71) Applicant: UPL LTD, Mumbai (IN)

(72) Inventors: Satish Ekanath Bhoge, Mumbai (IN); Sanjay Saraph, Mumbai (IN)

(21) Appl. No.: 17/603,995

(22) PCT Filed: May 23, 2020
(86) PCT No.: PCT/IB2020/054916

§ 371 Date: Oct. 15, 2021

(30) Foreign Application Priority Data
May 24, 2019 (IN) 201921020716

(51) Int. Cl. A01N 43/56; A01N 25/22; A01N 25/10; A01N 43/40; A01N 47/30; A01N 43/707; A01N 25/14; A01P 7/04

(52) U.S. Cl. CPC A01N 43/56; A01N 25/22; A01N 25/10; A01P 7/04; A01N 47/30; A01N 43/707; A01N 25/14; A01N 43/40

(57) ABSTRACT

The present invention is related to a stable insecticide composition comprising: at least one agrochemical active ingredient, and a disintegration system. The present invention also provides process for preparation, use and method of controlling pests using said insecticidal composition.

### FIELD OF THE INVENTION

The present invention relates to a stable agrochemical composition. More particularly, the present invention relates to a stable insecticide composition with good stability and dispersibility. The stable insecticide composition of the present invention is useful for the protection of crops.

### BACKGROUND OF THE INVENTION

Many agrochemicals are currently supplied in the form of solid formulations such as powder, granular and wettable powder. Granular formulations offer various advantages, including (1) a higher apparent specific gravity than wettable powders or water-soluble products with less bulkiness, (2) no airborne scattering of fine powders when suspended in water to prepare spray liquids, meaning there is no danger for operators like absorbing chemical agents, and (3) easier weighing of the actives.

Granular products, more specifically, the Water Dispersible Granules (WDGs) are a solid, non-dusty formulations which disperses or dissolves quickly when added to water in the spray tank to give a fine particle suspension. They provide a system for delivering solid active ingredients to a target organism. They allow to produce highly-concentrated formulations which are wettable and easily disintegrated on contact with water. WDGs are important delivery vehicles for active agrochemicals because, unlike emulsion concentrates, they are solvent-free, do not have dusting problems like wettable powders (WP's), and can be transported more economically than suspension concentrates (SC's). Also, packaging material used for WDG's is biodegradable whilst it is not the case with WP's and SC's.

When agrochemicals have relatively similar water solubility profile, preparation, storage and shipping in a commercially acceptable form can be relatively easier. However, many agrochemicals having diverse solubility profile are required to be combined in a single composition based on desired biological effect. Such agrochemicals when combined together to form WDG, disintegration of such WDG becomes the major concern which is to be addressed.

In an agrochemical application, a wide variety of water insoluble actives are delivered in aqueous suspension. Water insoluble materials which may advantageously be used in WDG formulations include insecticides, herbicides, fungicides, biocides, molluscicides, algaicides, plant growth regulators, anthelmintics, rodenticides, nematocides, acaricides, amoebicides, protozoacides, crop safeners and adjuvants. A wide variety of other insoluble materials are used in agricultural applications including fillers and carriers, for example but not limited to, natural and synthetic silicates and silicate minerals, mineral oxides and hydroxides and natural and synthetically derived organic materials. Such materials may be added as porous carriers, as moisture inhibition agents, to aid binding or agglomeration properties of a formulation or simply to fill a formulation to a convenient weight. Examples of such fillers may include natural silicates such as diatomaceous earth, synthetic precipitated silicas, clays such as kaolin, attapulgites and bentonites, zeolites, titanium dioxide, iron oxides and hydroxides, aluminium oxides and hydroxides, or organic materials such as bagasse, charcoal, or synthetic organic polymers.

Disintegration is frequently a prerequisite for the efficient dispersion of WDGs in water and also an important index for evaluating the performance of WDGs. Although WDG formulations are optimized to improve disintegration properties but there have been limited research on the factors influencing the disintegration performance of WDGs, especially in case of hydrophobic agrochemical active ingredients. It is known that the WDGs with weak bonding proved to facilitate rapid disintegration and dispersion. Also, another factor influencing disintegration is the porosity and the package rate of the surfactant on the pesticide particles surface.

There is still no comprehensive and systematic theory for the WDG disintegration mechanism, and researchers mainly depend on their experience to improve the disintegration property, which restricts the development of a high-performance WDG pesticide. Water wetting the surface and diffusing to the inner space of WDGs have been identified as steps necessary in any disintegration process, so an appropriate porosity is essential for WDGs to achieve sufficient disintegration.

Various disintegrating agents are known in the art which are used in water dispersible granules. However, there is a need for new and improved disintegration system which improves the stability of WDG formulations and provide instantaneous or fast release of active ingredients in the agrochemical formulation when intended to be used at desired site of application.

### OBJECTIVES OF THE INVENTION

Accordingly, it is a primary object of the present invention to provide a stable insecticide composition.

Another object of the present invention is to provide a stable insecticide composition in the form of water dispersible granules.

Another objective of the invention is to provide an insecticide composition with good stability and dispersibility comprising insecticidally effective amount of an agrochemical active ingredient and a disintegration system.

Yet another object of the present invention is to provide a process for preparing a stable insecticide composition.

Yet another object of the present invention to provide a method of controlling insects by using said stable insecticide composition.

### SUMMARY OF THE INVENTION

In an aspect the present invention provides a stable insecticide composition comprising:
at least one agrochemical active ingredient, and
a disintegration system,
   wherein said disintegration system comprises of a polymer matrix and an inorganic salt.

In another aspect the present invention provides a stable insecticide composition comprising:
at least one agrochemical active ingredient selected from the group comprising of hydrophobic agrochemical active ingredients and hydrophilic agrochemical active ingredients, and
a disintegration system,
   wherein said disintegration system comprises of a polymer matrix and an inorganic salt.

In another aspect, the stable insecticide composition comprising:
at least one hydrophilic agrochemical active ingredient,
at least one hydrophobic agrochemical active ingredient, and
a disintegration system,
   wherein said disintegration system comprises of a polymer matrix and an inorganic salt.

In another aspect, the stable insecticide composition comprising:
at least one hydrophilic agrochemical active ingredients selected from the group comprising of pyridine organic compound and organophosphorous compound;
at least one hydrophobic agrochemical active ingredient selected from the group comprising of phenyl pyrazole compound, diamide, triazine, pyrethroids, oxadiazine and thiourea class of compounds; and
a disintegration system,
   wherein disintegration system comprises of a polymer matrix and an inorganic salt in an effective ratio.

In another aspect, there is provided water dispersible granular formulation comprising:
at least one hydrophilic agrochemical active ingredients selected from the group comprising of pyridine organic compound and organophosphorous compound;
at least one hydrophobic agrochemical active ingredient selected from the group comprising of phenyl pyrazole compound, diamide, triazine, pyrethroids, oxadiazine and thiourea class of compounds; and
a disintegration system,
   wherein disintegration system comprises of a polymer matrix and an inorganic salt in an effective ratio.

In accordance with the above objectives, a process for preparation of stable insecticide composition said process comprising steps of:
i) adding agrochemically active ingredient, a polymer matrix and optionally other auxiliary ingredients and blending it to obtain blend;
ii) grinding the blend to obtain grounded mix of desired particle size;
iii) blending the grounded mix to obtain homogeneous mixture;
iv) preparing dough from the homogeneous mixture and perform granulation;
v) drying the granules to obtain the finished composition.

Typically, the blend in step ii) is subjected to grinding to obtain grounded mix of desired particle size preferably D50 below 5 microns and D90 below 10 microns and D100 below 30 microns.

In accordance with the above objective, the present invention provides use of stable insecticide composition according to the present invention as a pesticide for controlling insects.

In accordance with the above objectives, the present invention provides a method of controlling unwanted pests especially insects said method comprising, applying an effective amount of stable insecticide compositions comprising;
at least one agrochemical active ingredient, and
a disintegration system,
   wherein said disintegration system comprises of a polymer matrix and an inorganic salt to the pests or to their locus.

In accordance with the above objectives, a kit comprising said stable insecticide composition according to the present invention.

Additional features and advantages of the present invention will be apparent from the detailed description that follows, which illustrates by way of example, the most preferred features of the present invention which are not to be construed as limiting the scope of the invention described herein.

### DETAILED DESCRIPTION OF THE INVENTION

The present invention relates to solid formulations of pesticidally effective amount of active ingredient with specific disintegration system to prevent degradation of active compounds. Surprisingly, inventors of the present invention found that disintegration system in accordance with the present invention that is a combination of a polymer matrix and an inorganic salt work dramatically better, and sometimes even synergistically, to improve disintegration profile of water dispersible granules than either component alone. The polymer matrix and inorganic salt combination intensely enhance the disintegration profile of compositions of hydrophilic agrochemical active ingredients with one or more agrochemical active ingredient.

Inventors of the invention found that the polymer matrix influence the disintegration profile of active ingredient and its release in the water to form suspension. Polymer matrix absorbs water through diffusion and holds it in a more controlled manner. This makes water available to disintegrate active ingredients. Similarly, inorganic salts facilitate pore formation in the composition during drying procedure of water dispersible granules and create channels that facilitate passage of water in the granule to easily disperse in water to form suspension for end-use.

Therefore, present invention relates to a stable insecticide composition comprising:
at least one agrochemical active ingredient, and
a disintegration system,
   wherein said disintegration system comprises of a polymer matrix and an inorganic salt.

In an embodiment, the agrochemical active ingredient is selected from the group of hydrophobic agrochemical active ingredients and hydrophilic agrochemical active ingredients or combinations thereof.

In an embodiment, the hydrophobic agrochemical active ingredient is selected from the group comprising of phenyl pyrazole compound, diamide, triazine, pyrethroids, oxadiazine and thiourea class of compounds.

In an embodiment the hydrophilic agrochemical active ingredient is selected from the group comprising of pyridine organic compounds, organophosphorous compounds, neonicotinoids, dithiocarbamates, phthalimides, triazines, their derivatives and salts thereof.

In an embodiment the hydrophilic agrochemical active ingredient is selected from the group comprising of pyridine organic compounds and organophosphorous compounds.

Examples of hydrophilic agrochemical active ingredient include but not limited to, flonicamid, glufosinate and its salts, glyphosate and its salts , acephate, acifluorfen, bispyribac sodium, pyrazosulfuron ethyl, 2,4-D sodium salt, pymetrozine, emamectin-benzoate acetamiprid, imidacloprid, thiamethoxam spinosad captafol, captan zineb, ziram fentin acetate fentin hydroxide, captafol, captan zineb, ziram ferbam folpet, fosetyl-aluminium, fosetyl-sodium copper preparations, such as: copper hydroxide, copper naphthenate, copper oxychloride, copper sulphate, copper oxide, oxine-copper and Bordeaux mixture, mancopper, mancozeb, maneb, propineb and salts thereof.

In preferred embodiment of the present invention, hydrophilic agrochemical active ingredient is selected from the group of flonicamid, glufosinate salt, glyphosate salts, pymetrozine, acephate and captan.

According to the preferred embodiment of the present invention, the hydrophilic agrochemical active ingredient is flonicamid.

According to an embodiment of the present invention, hydrophilic agrochemical active ingredient is glufosinate, its salts and derivative thereof.

According to an embodiment of the present invention, hydrophilic agrochemical active ingredient is pymetrozine.

According to an embodiment of the present invention, hydrophilic agrochemical active ingredient is acephate.

In an embodiment, the present invention provides a stable insecticide composition comprising from about 0.1% w/w to about 90% w/w and preferably from about 1% w/w to about 80% w/w hydrophilic agrochemical active ingredient of the total weight of the stable agrochemical composition.

In a preferred embodiment of the present invention, the stable insecticide composition comprises from about 5% w/w to about 80% w/w hydrophilic agrochemical active ingredient of the total weight of the stable agrochemical composition.

According to an embodiment of the present invention, the stable insecticide compositions comprises of hydrophobic agrochemical active ingredients.

According to an embodiment of the present invention, the stable insecticide compositions comprises of hydrophobic agrochemical active ingredients selected from group comprising of phenyl pyrazole compound, diamide, triazinone, pyrethroids, oxadiazine, thiourea, their derivatives and salts thereof.

According to an embodiment of the present invention, the hydrophobic agrochemical active ingredients are selected from the group comprising of fipronil, flubendiamide, clodinafop, metribuzin, diafenthiauron, indoxacarb, bifenthrin, fluazuron, atrazine, deltamethrin, rimsulfuron, imidacloprid, fomesafen, acifluorfen, azaconazole, azoxystrobin, benalaxyl, benodanil, 1, benzamacril, benzamacryl-isobutyl, bialaphos, binapacryl, biphenyl, bitertanol, blasticidin-S, bromuconazole, bupirimate, buthiobat, calcium polysulphide, capsimycin, carbendazim, carboxin, carvone, chinomethionat (quinomethionat), chlobenthiazone, chlorfenazole, chlorothalonil, chlozolinate, clozylacon, cufraneb, cymoxanil, cyproconazole, cyprodinil, cyprofuram, debacarb, dichlorophen, diclobutrazol, diclofluanid, diclomezine, dicloran, diethofencarb, difenoconazole, diafenthiuron, dime thirimol, dithianon, dodemorph, dodine, drazoxolon, ediphenphos, epoxiconazole, etaconazole, ethirimol, etridiazole, famoxadone, fenapanil, fenarimol, fenbuconazole, fenfuram, fenitropan, fenpiclonil, fenpropidin, fenpropimorph, fluquinconazole, flurprimidol, flusilazole, flusulphamide, flutolanil, imibenconazole, iminoctadine, iminoctadinealbesilate, iminoctadine, iprodione, irumamycin, isoprothiolane, isovaledione, kasugamycin, kresoxim-methyl, meferimzone, mepanipyrim, mepronil, metalaxyl, metconazole, methasulphocarb, methfuroxam, myclobutanil, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur, Sulphur and sulphur preparations, tebuconazole, tecloftalam, tecnazene, tetcyclacis, tetraconazole, thiabendazole, thifluzamide, thiophanate-methyl, tricyclazole, tridemorph, triflumizole, triforine, triticonazole, avermectin lorfenapyr fenazaquin, fenpyroximate, pyrimidifen, pyridaben, tebufenpyrad, tolfenpyrad Diafenthiuron spirodiclofen, spiromesifen amidoflumet, benclothiaz, benzoximate, bifenazate, bromopropylate, buprofezin, chinomethionat, chlordimeform, chlorobenzilate, chloropicrin, clothiazoben, cycloprene, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulphluramid, tetradifon, tetrasul, triarathene, chlorantraniliprole, chlorfenapyr, clothianidin, cyantraniliprole, diafenthiuron, emamectin benzoate, ethiprole, flupyradifurone, imidacloprid, indoxacarb, lambda cyhalothrin, lufenuron, methoxyfenozide, pymetrozine, pyrethrum, bistrifluoron, chlofluazuron, diflubenzuron, fluazuron, flucycloxuron, flufenoxuron, hexaflumuron, lufenuron, novaluron, noviflumuron, penfluoron, teflubenzuronchromafenozide, halofenozide, methoxyfenozide and tebufenozide.

According to an embodiment of the present invention, hydrophobic agrochemical active ingredients are selected from the group comprising of fipronil, flubendiamide, metribuzin, indoxacarb, diafenthiuron and bifenthrin.

According to the preferred embodiment of the present invention, hydrophobic agrochemical active ingredient is fipronil.

According to the preferred embodiment of the present invention, hydrophobic agrochemical active ingredient is diafenthiuron.

In an embodiment, the present invention provides a stable insecticide composition comprising from about 0.1% w/w to about 90% w/w and preferably from about 1% w/w to about 80% w/w hydrophobic agrochemical active ingredient of the total weight of the stable insecticide composition.

In a preferred embodiment of the present invention, the stable insecticide composition comprises from about 5% w/w to about 80% w/w hydrophobic agrochemical active ingredient of the total weight of the stable agrochemical composition.

According to an embodiment of the present invention, the stable insecticide composition comprises of a disintegration system.

According to an embodiment of the present invention, the disintegration system comprises of a polymer matrix and an inorganic salt.

The term ‘disintegration system’ used herein refers to disintegration system comprising a polymer matrix and an inorganic salt, in an effective ratio preferably from about 1:1 to about 1:4.

According to an embodiment of the present invention, polymer matrix is selected from the group comprising of polyurea, polyvinyl chloride, polyurethanes, polyamide, polyvinyl pyrrolidine, acrylic polymers, polyisocyanate-cyclic alkylene, polyamine, polyimine, polycarboxylic acids, naturally occurring polymers, their derivatives and salts thereof.

According to an embodiment of the present invention, naturally occurring polymers in polymer matrix is selected from the group comprising of kaolin, clay, bentonite, diatomaceous earth, zeolite, attapulgite, acid clay, talc and the like.

According to preferred embodiment of the present invention, polymer matrix is polyurea and polyurethane.

According to preferred embodiment of the present invention, polymer matrix is polyurea, also known as urea-formaldehyde copolymer (Marketed as BC700™, Urecoll®, Leaf®, E-Gen®, Meldur®, GripPro™).

In an embodiment, the present invention provides a stable insecticide composition comprising from about 0.1% w/w to about 50% w/w and preferably from about 1% w/w to about 30% w/w polymer matrix of the total weight of the stable insecticide composition.

In a preferred embodiment of the present invention, the stable insecticide composition comprises from about 0.5% w/w to about 20% w/w polymer matrix of the total weight of the stable insecticide composition.

According to an embodiment of the present invention, an inorganic salt of the stable insecticide composition is selected from the group comprising of ammonium sulfate, sodium sulfate, ammonium bicarbonate, sodium bicarbonate, magnesium sulfate, hydrogen carbonate, sodium chloride, sodium citrate, ammonium citrate, sodium acetate bentonite, aluminium chloride, citric acid, succinic acid and the like.

According to preferred embodiment of the present invention, inorganic salt is ammonium bicarbonate.

According to preferred embodiment of the present invention, inorganic salt is ammonium sulfate.

According to preferred embodiment of the present invention, inorganic salt is sodium citrate.

In an embodiment of the present invention, a stable insecticide composition comprising from about 0.1% w/w to about 30% w/w and preferably from about 0.5% w/w to about 30% w/w inorganic salt of the total weight of the stable insecticide composition.

In a preferred embodiment of the present invention, the stable insecticide composition comprises from about 1% w/w to about 20% w/w inorganic salt of the total weight of the stable insecticide composition.

According to an embodiment of the present invention, the stable insecticide composition comprising:
at least one hydrophilic agrochemical active ingredients selected from the group comprising of pyridine organic compound and organophosphorous compounds;
   at least one hydrophobic agrochemical active ingredient selected from the group comprising of phenyl pyrazole compound, diamide, triazine, pyrethroids, oxadiazine and thiourea class of compounds; and
   a disintegration system;
      wherein disintegration system comprises of a polymer matrix and an inorganic salt in a ratio from about 1:1 to about 1:4.

In an embodiment, the disintegration system comprises of a polymer matrix and an inorganic salt in a ratio of about 1:1 or about 1:1.5 or about 1: 2 or about 1:2.5 or about 1:3 or about 1: 3.5 or about 1:4.

In preferred embodiment, the disintegration system comprises of a polymer matrix and an inorganic salt in a ratio of about 1:1.

In another embodiment, the disintegration system comprises of a polymer matrix and an inorganic salt in a ratio of about 1:4.

In another embodiment, according to the present invention, degradation of said agrochemical active ingredients is controlled.

In another embodiment, according to the present invention, degradation of said agrochemical active ingredients is controlled to <5%. The degradation of said agrochemical active ingredients in the present composition is preferably controlled to <3%, more preferably <2% and most preferably <1%.The stable insecticide composition of the present invention may further comprise one or more dispersants, wetting agents, fillers, surfactants, anticaking agents, pH-regulating agents, preservatives, biocides, antifoaming agents, colorants and other formulation aids.

The examples of dispersants may be selected from ionic and nonionic dispersants to enable disintegration of granules in water with ease, such as salts of polystyrene sulphonic acids, salts of polyvinylsulphonic acids, salts of naphthalenesulphonic acid/formaldehyde condensates, salts of condensates of naphthalenesulphonic acid, phenolsulphonic acid and formaldehyde, and salts of lignosulphonic acid e.g frequently used dispersants are alkylnaphtalene sulphonates, for instance sodium diisopropylnaphthalene sulphonate and sodium alkylnaphthalene sulphonate, and lignosulphonate, such as sodium lignosulphonate and modified sodium lignosulfonate (Ufoxane 3A); polyethylene oxide/polypropylene oxide block copolymers, polyethylene glycol ethers of linear alcohols, reaction products of fatty acids with ethylene oxide and/or propylene oxide, furthermore polyvinyl alcohol, polyvinylpyrrolidone, copolymers of polyvinyl alcohol and polyvinylpyrrolidone and copolymers of (meth)acrylic acid and (meth)acrylic esters, furthermore alkyl ethoxylates and alkylarylethoxylates ethoxylated alkylarylphosphated and sulphated ester. The preferred dispersing agents include derivative of ethoxylates of vegetable oil or a mixture of one or more of these; or styrene acrylic polymers or mixtures thereof.

The examples of wetting agents may be selected from soaps; silicone oil, magnesium stearate, salts of aliphatic monoesters of sulphuric acid including but not limited to sodium lauryl sulphate; sulfoakylamides and salts thereof including but not limited to N-methyl-N-oleoyltaurate sodium salt; alkylarylsulfonates including but not limited to akylbenzenesulfonates; akylnaphthalenesulfonates and salts thereof and salts of ligninsulfonic acid, e.g. sodium diisopropyl naphthalene sulfonate (Supragil WP).

In an embodiment the fillers may be selected from insoluble fillers and soluble fillers.

In an embodiment, the preferred fillers are selected from precipitated silica and diatomaceous earth kaolin.

In an embodiment, suitable antifoams may, preferably be, silicones, long-chain alcohols and salts of fatty acids.

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

According to an embodiment of the present invention, the stable insecticide composition of the present invention is preferably formulated as a solid composition including, but not limited to, dust, powder, granules, pellets, tablets, dry flowable, wettable powder or water dispersible granules (WDG).

In a preferred embodiment, the stable insecticide composition of the present invention is a Water Dispersible Granules (WDG).

In an embodiment the present invention provides a water dispersible granular formulation comprising:
at least one hydrophilic agrochemical active ingredients selected from the group comprising of pyridine organic compound and organophosphorous compounds;
at least one hydrophobic agrochemical active ingredient selected from the group comprising of phenyl pyrazole compound, diamide, triazine, pyrethroids, oxadiazine and thiourea class of compounds; and
a disintegration system;
   wherein disintegration system comprises of a polymer matrix and an inorganic salt.

Inventors of the present invention successfully prepared the insecticidal compositions of agrochemically active ingredients as well as combination of agrochemically active ingredients with diverse solubility profile using disintegration system comprising a polymer matrix and inorganic salt. The compositions of hydrophilic agrochemical active ingredient, hydrophobic agrochemical active ingredient along with disintegration system surprisingly found to remain stable with desired suspensibility and dispersibility. Also, agrochemical active ingredients remain quite stable without any significant degradation of the actives in various compositions developed according to the present invention. The present composition also demonstrate reduced use rates as well as reduction in dust hazard.

According to an embodiment of the present invention, the stable insecticide composition comprises of flonicamid and a disintegration system comprises of a polymer matrix and an inorganic salt in a ratio from about 1:1 to about 1:4.

According to an embodiment of the present invention, the stable insecticide composition comprises of fipronil and a disintegration system comprises of a polymer matrix and an inorganic salt in a ratio from about 1:1 to about 1:4.

According to an embodiment of the present invention, the stable insecticide composition comprises of fipronil, flonicamid and a disintegration system comprises of a polymer matrix and an inorganic salt in a ratio from about 1:1 to about 1:4. According to an embodiment of the present invention, the stable insecticide composition comprises of diafenthiuron, flonicamid and a disintegration system comprises of a polymer matrix and an inorganic salt in a ratio from about 1:1 to about 1:4.

According to an embodiment of the present invention, the stable insecticide composition comprises of fipronil, pymetrozine and a disintegration system comprises of a polymer matrix and an inorganic salt in a ratio from about 1:1 to about 1:4.

In preferred embodiment the water dispersible granular formulation comprising:
at least one hydrophilic agrochemical active ingredients selected from the group comprising of pyridine organic compound and organophosphorous compounds;
at least one hydrophobic agrochemical active ingredient selected from the group comprising of phenyl pyrazole compound, diamide, triazine, pyrethroids, oxadiazine and thiourea class of compounds; and
a disintegration system;
   wherein disintegration system comprises of a polymer matrix and an inorganic salt in a ratio from about 1:1 to about 1:4.

In preferred embodiment, the present invention provides a water dispersible granular formulation comprising
i) flonicamid and
ii) a disintegration system comprises of a polymer matrix and an inorganic salt in a ratio from about 1:1 to about 1:4.

In preferred embodiment, the present invention provides a water dispersible granular formulation comprising
i) Fipronil and
ii) a disintegration system comprises of a polymer matrix and an inorganic salt in a ratio from about 1:1 to about 1:4.

In another preferred embodiment, the present invention provides a water dispersible granular formulation comprising
i) Flonicamid;
ii) Fipronil and
iii) a disintegration system comprises of a polymer matrix and an inorganic salt in a ratio from about 1:1 to about 1:4.

In another preferred embodiment, the present invention provides a water dispersible granular formulation comprising
i) Flonicamid;
ii) Difenthiuron and
iii) a disintegration system comprises of a polymer matrix and an inorganic salt in a ratio from about 1:1 to about 1:4.

In another preferred embodiment, the present invention provides a water dispersible granular formulation comprising
i) Pymetrozine;
ii) Fipronil and
iii) a disintegration system comprises of a polymer matrix and an inorganic salt in a ratio from about 1:1 to about 1:4.

In an embodiment, the present invention provides a stable insecticide composition comprising from about 0.1% w/w to about 90% w/w hydrophilic agrochemical active ingredient, and from about 0.1% w/w to about 30% w/w disintegration system with polymer matrix and inorganic salt in a ratio 1:1 to 1:4 of the total weight of the composition.

In an embodiment, the present invention provides a stable insecticide composition comprising from about 0.1% w/w to about 80% w/w hydrophilic agrochemical active ingredient, and from about 0.1% w/w to about 30% w/w disintegration system with polymer matrix and inorganic salt in a ratio 1:1 to 1:4 of the total weight of the composition.

In a preferred embodiment, the present invention provides a stable insecticide composition comprising from about 50% w/w to about 90% w/w flonicamid, from about 0.1% w/w to about 20% w/w ammonium sulfate and from about 0.1% w/w to 20% w/w urea-formaldehyde copolymer of the total weight of the composition.

In an embodiment, the present invention provides a stable insecticide composition comprising from about 0.1% w/w to about 90% w/w hydrophobic agrochemical active ingredient, and from about 0.1% w/w to about 30% w/w disintegration system with polymer matrix and inorganic salt in a ratio 1:1 to 1:4 of the total weight of the composition.

In an embodiment, the present invention provides a stable insecticide composition comprising from about 0.1% w/w to about 80% w/w hydrophobic agrochemical active ingredient, and from about 0.1% w/w to about 30% w/w disintegration system with polymer matrix and inorganic salt in a ratio 1:1 to 1:4 of the total weight of the composition.

In a preferred embodiment, the present invention provides a stable insecticide composition comprising from about 50% w/w to about 90% w/w fipronil, from about 0.1% w/w to about 20% w/w ammonium sulfate and from about 0.1% w/w to 20% w/w urea-formaldehyde copolymer of the total weight of the composition.

In an embodiment, the present invention provides a stable insecticide composition comprising from about 0.1% w/w to about 90% w/w hydrophilic agrochemical active ingredient, from about 0.1% w/w to about 90% w/w hydrophobic agrochemical active ingredient, and from about 0.1% w/w to about 30% w/w disintegration system with polymer matrix and inorganic salt in a ratio 1:1 to 1:4 of the total weight of the composition.

In a preferred embodiment, the present invention provides a stable insecticide composition comprising from about 5% w/w to about 80% w/w hydrophilic agrochemical active ingredient, from about 5% w/w to about 80% w/w hydrophobic agrochemical active ingredient and from about 0.1% w/w to about 30% w/w disintegration system with polymer matrix and inorganic salt in a ratio from about 1:1 to about 1:4 of the total weight of composition.

In a preferred embodiment, the present invention provides a stable insecticide composition comprising from about 5% w/w to about 80% w/w flonicamid, from about 5% w/w to about 80% w/w fipronil, from about 1% w/w to about 20% w/w ammonium sulfate and from about 1% w/w to about 20% w/w urea-formaldehyde copolymer of the total weight of the composition.

In a preferred embodiment, the present invention provides a stable insecticide composition comprising from about 5% w/w to about 30% w/w flonicamid, from about 5% w/w to about 30% w/w fipronil, from about 0.1% w/w to about 20% w/w ammonium sulfate and from about 0.1% w/w to 20% w/w urea-formaldehyde copolymer of the total weight of the composition.

In a preferred embodiment, the present invention provides a stable insecticide composition comprising from about 5% w/w to about 30% w/w flonicamid, from about 5% w/w to about 70% w/w diafenthiuron, from about 0.1% w/w to about 20% w/w ammonium sulfate and from about 0.1% to 20% w/w urea-formaldehyde copolymer of the total weight of the composition.

In a preferred embodiment, the present invention provides a stable insecticide composition comprising from about 5% w/w to about 30% w/w fipronil, from about 5% w/w to about 40% w/w pymetrozine, from about 0.1% w/w to about 20% w/w ammonium sulfate and from about 0.1% w/w to 20% w/w urea-formaldehyde copolymer of the total weight of the composition.

In one preferred embodiment of the present invention, the stable insecticide composition comprising from about 50% w/w to about 90% w/w flonicamid, from about 0.1% w/w to about 20% w/w ammonium sulfate and from about 0.1% w/w to 20% w/w urea-formaldehyde copolymer of the total weight of the stable insecticide composition and wherein said composition is in the form of water dispersible granules.

In an embodiment of the present invention, the stable insecticide composition comprising from about 50% w/w to about 90% w/w fipronil, from about 0.1% w/w to about 20% w/w ammonium sulfate and from about 0.1% w/w to 20% w/w urea-formaldehyde copolymer of the total weight of the stable insecticide composition and wherein said stable insecticide composition is in the form of water dispersible granules.

In another preferred embodiment of the present invention the stable insecticide composition comprising from about 5% w/w to about 30% w/w flonicamid, from about 5% w/w to about 30% w/w fipronil, from about 0.1% w/w to about 20% w/w ammonium sulfate and from about 0.1% w/w to 20% w/w urea-formaldehyde copolymer of the total weight of the stable insecticide composition and wherein said stable insecticide composition is in the form of water dispersible granules.

In a preferred embodiment, the present invention provides a stable insecticide composition comprising from about 5% w/w to about 30% w/w flonicamid, from about 5% w/w to about 70% w/w diafenthiuron, from about 0.1% w/w to about 20% w/w ammonium sulfate and from about 0.1% to 20% w/w urea-formaldehyde copolymer of the total weight of the composition.

In a preferred embodiment, the present invention provides a stable insecticide composition comprising from about 5% w/w to about 30% w/w fipronil, from about 5% w/w to about 40% w/w pymetrozine, from about 0.1% w/w to about 20% w/w ammonium sulfate and from about 0.1% w/w to 20% w/w urea-formaldehyde copolymer of the total weight of the composition.

In another embodiment the insecticide composition according to the present invention can comprises another insecticide selected from group of Acetylcholinesterase (AChE) inhibitors, GABA-gated chloride channel blockers, Sodium channel modulators, Nicotinic acetylcholine receptor (nAChR) competitive modulators, Nicotinic acetylcholine receptor (nAChR) allosteric modulators, Glutamate-gated chloride channel (GluCl) allosteric modulators, Juvenile hormone mimics, Chordotonal organ TRPV channel modulators, Mite growth inhibitors, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis , Moulting disruptors, Ecdysone receptor agonists, Octopamine receptor agonists, Mitochondrial complex electron transport inhibitors, Voltage-dependent sodium channel blockers, Inhibitors of acetyl CoA carboxylase, Chordotonal organ Modulators, multi-site miscellaneous insecticides, bioinsecticides and mixtures thereof.

According to an embodiment of the present invention, a process for preparation of stable insecticide composition, said process comprising steps of:
i) mixing an agrochemically active ingredient, a polymer matrix and an inorganic salt and blending to obtain blend;
ii) grinding said blend to obtain grounded mix of desired particle size;
iii) blending said grounded mix to obtain homogeneous mixture;
iv) preparing dough from said homogeneous mixture and perform granulation and
v) drying the granules.

According to an embodiment of the present invention, a process for preparation of stable insecticide composition, said process comprising steps of:
i) adding hydrophilic agrochemical active ingredient, hydrophobic agrochemical active ingredient, a polymer matrix and an inorganic salt and blending it to obtain blend;
ii) grinding said blend to obtain grounded mix of desired particle size;
iii) blending said grounded mix to obtain homogeneous mixture;
iv) preparing dough from said homogeneous mixture and perform granulation;
v) drying the granules.

According to an embodiment of the present invention, provided is a process for the preparation of a water dispersible granular formulation comprising flonicamid and fipronil.

According to an embodiment of the present invention, the process for preparation of water dispersible granular formulation comprising the steps of:
i) adding flonicamid, fipronil, ammonium sulfate, urea-formaldehyde copolymer and other auxiliary ingredients and blending it to obtain the blend;
ii) grinding said blend to obtain grounded mix of desired particle size;
iii) blending said grounded mix to obtain homogeneous mixture;
iv) preparing dough from said homogeneous mixture by adding water and extrude the granules;
v) drying the extruded granules.

According to an embodiment of the present invention, the order of addition and mixing of the granule ingredients is not narrowly critical. In one embodiment, for example, the dry ingredients are blended and the composition is then mixed while water is added.

According to an embodiment of the present invention, water may be added as a fine spray to prepare dough from the composition to obtain granules.

According to an embodiment of the present invention, one or more formulation auxiliaries are added in water to prepare aqueous solution and said aqueous solution is added to prepare dough from the composition to obtain granules.

According to an embodiment of the present invention, the blend of above ingredients is obtained using a suitable blender such as ribbon blender, V-blender, high intensity plow mixer or the like.

According to an embodiment of the present invention, the grinding may be performed in a suitable device known to a skilled person in the relevant art such as air jet mill, air classifier mill, hammer mill, pin disc mill or the like. Jet mills are shear or pulverizing machines in which the particles to be milled are accelerated by gas flows and pulverized by collision. There are a number of different types of jet mill designs, such as double counterflow (opposing jet) and spiral (pancake) fluid energy mills.

According to an embodiment of the present invention, water dispersible granules are typically prepared through an extrusion process or pan granulation process.

According to an embodiment of the present invention, drying of granules may be performed in a suitable drying equipment such as spray drier or fluidized bed spray drier or fluid bed spray granulator.

According to an embodiment of the present invention, the drying of extruded granules operates at a temperature not more than 90° C.-100° C.

According to preferred embodiment of the present invention, the drying of granules operates at a temperature range of 50° C.-70° C.

The drying process will preferably remove as much water as possible in order to reduce weight and to provide good stability to the granules while still in a dry flowable state.

Preferably the granules will be dried to less than 2% as weight loss on complete drying and most preferably dried to less than 0.5% as weight loss on complete drying.

According to an embodiment of the present invention, materials used in the process of the invention may be in a finely divided form, preferably in an air-milled form which is generally the form of technical grade chemicals supplied by manufacturers.

After thorough mixing or after otherwise putting the mix into a form suitable for extrusion, extrusion takes place through suitable orifices. The size of the granules will depend upon the size of the orifices and the extruder may thus be fitted with a mesh or die selected to provide a desired size of granule. Preferably extrusion orifices will be chosen to provide extrusions between 300 and 1000 microns in diameter. The extrusions can vary considerably in length, e.g. up to 0.5 cm or more long.

In an embodiment of the present invention, pH of the stable insecticide composition is adjusted between 5 to 8.

In an embodiment of the present invention, the process of preparing stable insecticide composition comprises steps of:
i) adding hydrophilic agrochemical active ingredient, hydrophobic agrochemical active ingredient, a polymer matrix and an inorganic salt and blending it to obtain blend;
ii) grinding said blend to obtain grounded mix of desired particle size;
iii) blending said grounded mix to obtain homogeneous mixture and
iv) preparing dough from said homogeneous mixture and perform granulation to obtain the composition.

The granules thus obtained by granulation are subjected to drying at temperature lesser than 100° C. to reduce moisture content less than 0.5% to obtain the finished composition.

It will be evident to those skilled in the art that one significant advantage of the process of the present invention is that the extrusions are not reduced (e.g. by cutting) to granules as they exit the extruder. This means that the rate of extrusion is not limited by the rate at which the extrusions can be broken down into granules and high extrusion rates can be used. This results in the process of the present invention being significantly more cost-effective than prior art extrusion processes for producing water dispersible granules.

The process of the invention considerably reduces the amount of oversized and undersized material which must be recycled. Consequently, the granule composition is essentially dust free.

According to an embodiment of the present invention, the stable insecticide composition is used as pesticide to control insects in the agriculture field.

According to an embodiment of the present invention, the stable insecticide composition is effective as pesticides, for example, insecticides, miticides, nematicides and soil pesticides. For instance, the stable insecticide composition is against plant parasitic mites such as two-spotted spider mite (Tetranychus urticae), carmine spider mite (Tetranychus cinnabarinus) or citrus red mite (Panonychus citri) or bulb mite (Rhizoglyphus echinopus); aphids such as green peach aphid (Myzus persicae) or cotton aphid (Aphis gossypii); agricultural insect pests such as diamondback moth (Plutella xylostella), cabbage armyworm (Mamestra brassicae), common cutworm (Spodoptera litura), colorado potato beetle (Leptinotarsa decemlineata), codling moth (Laspeyresia pomonella), bollworm (Heliothis zea), tobacco budworm (Heliothis virescens), boll weevil (Anthonomus grandis), gypsy moth (Lymantria dispar), cucurbit leaf beetle (Aulacophora femoralis), planthoppers, leafhoppers, scales, bugs, whiteflies, thrips, grasshoppers, anthomyiid flies, scarabs, black cutworm (Agrotis ipsilon), cutworm (Agrotis segetum) or ants; hygienic insect pests such as tropical rat mite (Ornithonyssus bacoti), cockroaches, housefly (Musca domestica) or house mosquito (Culex pipiens pallens); stored grain insect pests such as angoumois grain moth (Sitotroga cerealella), azuki bean weevil (Callosobruchus chinensis), confused flour beetle (Tribolium confusum) or mealworms; household goods insect pests such as casemaking clothes moth (Tinea pellionella), black carpet beetle (Anthrenus scrophularidae) or subterranean termites; and other parasites on domestic animals such as fleas, lice or flies. Further, said composition is effective against insect pests such as aphids having acquired resistance to organophosphorus, carbamate and/or synthetic pyrethroid insecticides. Moreover, the agrochemically active ingredients of the present invention have excellent systemic properties, and by the application of the compounds of the present invention to soil treatment, not only noxious insects, noxious mites, noxious nematodes, noxious gastropods and noxious isopods in soil but also foliage pests can be controlled.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

According to an embodiment of the present invention, the stable insecticide composition comprising:
at least one agrochemical active ingredient; and
a disintegration system
   wherein said disintegration system comprises of a polymer matrix and an inorganic salt and said composition is useful in combatting insects such as while flies, mites, fruit borers and larvae.

According to an embodiment of the present invention, a method of controlling unwanted pests, said method comprising applying to the pests or to their locus, an agrochemically effective amount of stable agrochemical compositions comprising:
at least one agrochemical active ingredient; and
a disintegration system,
   wherein said disintegration system comprises of a polymer matrix and an inorganic salt.

According to an embodiment of the present invention, a method of controlling unwanted pests, said method comprising applying an agrochemically effective amount of stable agrochemical compositions comprising:
at least one hydrophilic agrochemical active ingredient;
at least one hydrophobic agrochemical active ingredient; and
a disintegration system,
   wherein disintegration system comprises of a polymer matrix and an inorganic salt in a ratio from about 1:1 to about 1:4.

According to an embodiment of the present invention, a method of controlling unwanted pests, said method comprising applying an agrochemically effective amount of stable agrochemical compositions to the pests or to their locus, said composition comprising flonicamid, fipronil, and a disintegration system comprising urea-formaldehyde copolymer and ammonium sulfate

According to an embodiment the compositions of the present invention can be in the form of a multi-pack product or as a kit-of-parts for controlling insects.

According to an embodiment of the present invention, the kit comprising:
at least one agrochemical active ingredient; and
a disintegration system,
   wherein said disintegration system comprises of a polymer matrix and an inorganic salt.

In one embodiment of the present invention, the kits may include one or more, including all, components that may be used to prepare the stable insecticide composition. E. g., kits may include hydrophilic agrochemical active ingredient, hydrophobic agrochemical active ingredient, and/or disintegration system. One or more of the components may already be combined together or pre-formulated. In those embodiments where more than two components are provided in a kit, the components may already be combined together and as such are packaged in a single container such as a vial, bottle, can, pouch, bag or canister.

In other embodiments, two or more components of a kit may be packaged separately, i. e., not pre-formulated. As such, kits may include one or more separate containers such as vials, cans, bottles, pouches, bags or canisters, each container containing a separate component for stable insecticide composition.

In both forms, a component of the kit may be applied separately from or together with the further components or as a component of a combination composition according to the invention for preparing the stable insecticide composition according to the invention.

In an embodiment of the present invention, the stable insecticide comprising (a) at least one agrochemical active ingredient, and (b) disintegration system is in the form of a kit with single pack or multi pack.

In an embodiment of the present invention, the stable insecticide composition comprising (a) at least one hydrophilic agrochemical active ingredient (b) at least one hydrophobic active ingredient and (c) disintegration system is in the form of a kit with single pack or multi pack.

In an embodiment, the multi-pack herbicidal product comprises a package holding a composition comprising at least one agrochemical active ingredient selected from hydrophobic and hydrophilic agrochemical active ingredient; and a disintegration system,

wherein said disintegration system comprises of a polymer matrix and an inorganic salt.

It will be understood that the specification and examples are illustrative but not limitative of the present invention and that other embodiments within the spirit and scope of the invention will suggest themselves to those skilled in the art. Other embodiments can be practiced that are also within the scope of the present invention. The following examples illustrate the invention, but by no means intend to limit the scope of the claims.

### EXAMPLE 1

### Preparation of Flonicamid 50% WDG

| # | Ingredients | Amount (%) |
|---|---|---|
| 1 | Flonicamid | 50 |
| 2 | Modified Sodium lignosulfonate | 6 |
| 3 | Sodium lignosulfonate | 10 |
| 4 | Sodium Isopropyl Naphthalene Sulfonate | 6 |
| 5 | Ammonium Sulphate | 5 |
| 6 | Urea-formaldehyde copolymer | 5 |
| 7 | Silicone defoamer | 0.5 |
| 8 | Kaolin | 17.5 |
| | Total | 100 |

Modified Sodium lignosulfonate (Ufoxane 3A);
Sodium Isopropyl Naphthalene Sulfonate (Supragil WP);
Urea-formaldehyde copolymer (BC-700); Silicone defoamer (SAG 1572).

Above mentioned ingredients in specified quantity were added and blended in a ribbon blender for 20-30 min to obtain blend. The blend was further grounded in air jet mill to obtain grounded mix having particle size D₁₀₀ below 30 micron. The grounded mix for then blended for 40-50 min to obtain homogeneous mixture. The homogeneous mixture was taken to prepare dough using water spray. Granules were then extruded in a granulator having sieve size 0.8 to 1.2 mm aperture. The extruded granules were dried on fluid bed dryer at temperature ranging between 50° C. to 70° C. The dried granules were passed through sieve to obtain uniformly sized granules. Undersized and oversized granules were recycled back. Finished granules were packed in a suitable packaging.

The formulations in the following examples are prepared according to the process described in example 1.

### EXAMPLE 2

### Preparation of Flonicamid 50% WDG

| # | Ingredients | Amount (%) |
|---|---|---|
| 1 | Flonicamid | 50 |
| 2 | Modified sodium lignosulphonate | 6 |
| 3 | Sodium lignosulfonate | 10 |
| 4 | Sodium Isopropyl Naphthalene Sulfonate | 6 |
| 5 | Ammonium Sulphate | 20 |
| 6 | Urea-formaldehyde copolymer | 5 |
| 7 | Silicone defoamer | 0.5 |
| 8 | Kaolin | 2.5 |
| | Total | 100 |

### EXAMPLE 3

### Preparation of Flonicamid 50% WDG (Comparative Example)

| # | Ingredients | Amount (%) |
|---|---|---|
| 1 | Flonicamid | 50 |
| 2 | Modified sodium lignosulfonate | 6 |
| 3 | Sodium lignosulfonate | 10 |
| 4 | Sodium Isopropyl Naphthalene Sulfonate | 6 |
| 5 | Urea-formaldehyde copolymer | 5 |
| 6 | Silicone defoamer | 0.5 |
| 7 | Kaolin | 22.5 |
| | Total | 100 |

### EXAMPLE 4

### Preparation of Flonicamid 50% WDG (Comparative Example)

| # | Ingredients | Amount (%) |
|---|---|---|
| 1 | Flonicamid | 50 |
| 2 | Modified sodium lignosulfonate | 6 |
| 3 | Sodium lignosulfonate | 10 |
| 4 | Sodium Isopropyl Naphthalene Sulfonate | 6 |
| 5 | Ammonium Sulphate | 20 |
| 6 | SAG 1572 | 0.5 |
| 7 | Kaolin | 7.5 |
| | Total | 100 |

### EXAMPLE 5

### Preparation of Flonicamid 50% WDG (Comparative Example)

| # | Ingredients | Amount (%) |
|---|---|---|
| 1 | Flonicamid | 50 |
| 2 | Modified sodium lignosulfonate | 6 |
| 3 | Sodium lignosulfonate | 10 |
| 4 | Sodium Isopropyl Naphthalene Sulfonate | 6 |
| 5 | Silicone defoamer | 0 |
| 6 | Kaolin | 27.5 |
| | Total | 100 |

### EXAMPLE 6

### Preparation of Fipronil 80% WDG

| # | Ingredients | Amount (%) |
|---|---|---|
| 1 | Fipronil | 80 |
| 2 | Modified sodium lignosulfonate | 3 |
| 3 | Sodium lignosulfonate | 8 |
| 4 | Sodium Isopropyl Naphthalene Sulfonate | 2 |
| 5 | Ammonium Sulphate | 2 |
| 6 | Urea-formaldehyde copolymer | 2 |
| 7 | Kaolin | 3 |
| | Total | 100 |

### EXAMPLE 7

### Preparation of Fipronil 80% WDG

| # | Ingredients | Amount (%) |
|---|---|---|
| 1 | Fipronil | 80 |
| 2 | Modified sodium lignosulfonate | 3 |
| 3 | Sodium lignosulfonate | 8 |
| 4 | Sodium Isopropyl Naphthalene Sulfonate | 2 |
| 5 | Ammonium Sulphate | 5 |
| 6 | Urea-formaldehyde copolymer | 2 |
| | Total | 100 |

### EXAMPLE 8

### Preparation of Fipronil 80% WDG (Comparative Example)

| # | Ingredients | Amount (%) |
|---|---|---|
| 1 | Fipronil | 80 |
| 2 | Modified sodium lignosulfonate | 3 |
| 3 | Sodium lignosulfonate | 8 |
| 4 | Sodium Isopropyl Naphthalene Sulfonate | 2 |
| 5 | Urea-formaldehyde copolymer | 2 |
| 6 | Kaolin | 5 |
| | Total | 100 |

### EXAMPLE 9

### Preparation of Fipronil 80% WDG (Comparative Example)

| # | Ingredients | Amount (%) |
|---|---|---|
| 1 | Fipronil | 80 |
| 2 | Modified sodium lignosulfonate | 3 |
| 3 | Sodium lignosulfonate | 8 |
| 4 | Sodium Isopropyl Naphthalene Sulfonate | 2 |
| 5 | Ammonium Sulphate | 5 |
| 6 | Kaolin | 2 |
| | Total | 100 |

### EXAMPLE 10

### Preparation of Fipronil 80% WDG (Comparative Example)

| # | Ingredients | Amount (%) |
|---|---|---|
| 1 | Fipronil | 80 |
| 2 | Modified sodium lignosulfonate | 3 |
| 3 | Sodium lignosulfonate | 8 |
| 4 | Sodium Isopropyl Naphthalene Sulfonate | 2 |
| 5 | Kaolin | 7 |
| | Total | 100 |

### EXAMPLE 11

### Preparation of Fipronil 15% and Flonicamid 15% WDG

| # | Ingredients | Amount (%) |
|---|---|---|
| 1 | Fipronil | 16.05 |
| 2 | Flonicamid | 16 |
| 3 | Modified sodium lignosulfonate | 6 |
| 4 | Sodium lignosulfonate | 10 |
| 5 | Sodium Isopropyl Naphthalene Sulfonate | 6 |
| 6 | Ammonium Sulphate | 7 |
| 7 | Urea-formaldehyde copolymer | 2 |
| 8 | Silicone defoamer | 0.5 |
| 9 | Kaolin | 36.45 |
| | Total | 100 |

### EXAMPLE 12

### Preparation of Fipronil 15% and Flonicamid 15% WDG

| # | Ingredients | Amount (%) |
|---|---|---|
| 1 | Fipronil | 16.05 |
| 2 | Flonicamid | 16 |
| 3 | Modified sodium lignosulfonate | 6 |
| 4 | Sodium lignosulfonate | 10 |
| 5 | Sodium Isopropyl Naphthalene Sulfonate | 6 |
| 6 | Ammonium Sulphate | 2 |
| 7 | Silicone defoamer | 0.5 |
| 8 | Urea-formaldehyde copolymer | 2 |
| 10 | Kaolin | 41.45 |
| | Total | 100 |

### EXAMPLE 13

### Preparation of Fipronil 15% and Flonicamid 15% WDG (Comparative Example)

| # | Ingredients | Amount (%) |
|---|---|---|
| 1 | Fipronil | 16.05 |
| 2 | Flonicamid | 16 |
| 3 | Modified sodium lignosulfonate | 6 |
| 4 | Sodium lignosulfonate | 10 |
| 5 | Sodium Isopropyl Naphthalene Sulfonate | 6 |
| 6 | Urea-formaldehyde copolymer | 2 |
| 7 | Silicone defoamer | 0.5 |
| 8 | Kaolin | 43.45 |
| | Total | 100 |

### EXAMPLE 14

### Preparation of Fipronil 15% and Flonicamid 15% WDG (Comparative Example)

| # | Ingredients | Amount (%) |
|---|---|---|
| 1 | Fipronil | 16.05 |
| 2 | Flonicamid | 16 |
| 3 | Modified sodium lignosulfonate | 6 |
| 4 | Sodium lignosulfonate | 10 |
| 5 | Sodium Isopropyl Naphthalene Sulfonate | 6 |
| 6 | Ammonium Sulphate | 7 |
| 8 | Silicone defoamer | 0.5 |
| 9 | Kaolin | 38.45 |
| | Total | 100 |

### EXAMPLE 15

### Preparation of Fipronil 15% and Flonicamid 15% WDG (Comparative Example)

| # | Ingredients | Amount (%) |
|---|---|---|
| 1 | Fipronil | 16.05 |
| 2 | Flonicamid | 16 |
| 3 | Modified sodium lignosulfonate | 6 |
| 4 | Sodium lignosulfonate | 9 |
| 5 | Sodium Isopropyl Naphthalene Sulfonate | 6 |
| 6 | Ammonium Sulphate | 2 |
| 7 | Silicone defoamer | 0.5 |
| 8 | Urea-formaldehyde copolymer | 7 |
| 9 | Kaolin | 40.45 |
| | Total | 100 |

### EXAMPLE 16

### Fipronil 30% +Flonicamid 30% w/w WDG

| # | Ingredients | Amount (%) |
|---|---|---|
| 1 | Fipronil | 31.63 |
| 2 | Flonicamid | 31.5 |
| 3 | Modified sodium lignosulfonate | 6 |
| 4 | Sodium Lignosulphonate | 10 |
| 5 | Sodium alkyl naphthalene sulfonate blend | 6 |
| 6 | Ammonium Sulphate | 7 |
| 7 | Silicone defoamer | 0.5 |
| 8 | Urea-formaldehyde copolymer | 2 |
| 9 | Kaolin | 5.37 |
| | Total | 100 |

Sodium alkyl naphthalene sulfonate blend (Morwet D425)

### EXAMPLE 17

### Fipronil 10% +Flonicamid 10% w/w WDG

| | | Amount |
|---|---|---|
| # | Ingredients | (%) |
| 1 | Fipronil | 10.5 |
| 2 | Flonicamid | 10.4 |
| 3 | Alkylnaphthalene sulfonate (ANS) condensate | 6 |
| 4 | Sodium Lignosulphonate | 12 |
| 5 | Sodium lauryl sulphate | 7 |
| 6 | Ammonium Sulphate | 7 |
| 7 | Silicone defoamer | 0.5 |
| 8 | Urea-formaldehyde copolymer | 4 |
| 9 | Kaolin | 42.6 |
| | Total | 100 |

### EXAMPLE 18

### Diafenthiuron 60% +Flonicamid 20% w/w WDG

| | | Amount |
|---|---|---|
| # | Ingredients | (%) |
| 1 | Diafenthiuron | 62 |
| 2 | Flonicamid | 21 |
| 3 | Modified styrene acrylic polymer | 8.5 |
| 4 | Sodium Isopropyl Naphthalene Sulfonate | 6 |
| 5 | Ammonium Sulfate | 1 |
| 6 | Urea-formaldehyde copolymer | 1 |
| 7 | Silicone defoamer | 0.5 |
| | Total | 100 |

### EXAMPLE 19

### Pymetrozine 35% +Fipronil 8% w/w WDG

| | | Amount |
|---|---|---|
| # | Ingredients | (%) |
| 1 | Pymetrozine | 36 |
| 2 | Fipronil | 21 |
| 3 | Potassium polycarboxylate | 3 |
| 4 | Sodium lignosulphonate | 12 |
| 5 | Ammonium Sulfate | 3 |
| 6 | Urea-formaldehyde copolymer | 3 |
| 7 | Silicone defoamer | 0.5 |
| 8 | Kaolin | 29 |
| | Total | 100 |

Potassium polycarboxylate (Geropon SC/213)

### EXAMPLE 20

### Stability Data

### Test for Dispersibility:

Compositions (as described above in Examples 1-10) prepared according to the present invention were tested for stability. The samples were prepared using varied quantities of the active ingredients and other ingredients as listed in the below table (Table 1). The samples were prepared as per the process given in Example 1. The samples were tested for dispersibility by observing the number of inversions required to achieve complete dispersion of active ingredients.

TABLE 1

| Ingredients | Examples | | | | | | | | | |
|---|---|---|---|---|---|---|---|---|---|---|
| Number | 1 | 2 | 3 | 4 | 5 | 6 | 7 | 8 | 9 | 10 |
| A | 50 | 50 | 50 | 50 | 50 | X | X | X | X | X |
| B | X | X | X | X | X | 80 | 80 | 80 | 80 | 80 |
| C | 5 | 5 | 5 | X | X | 2 | 2 | 2 | X | X |
| D | 5 | 20 | X | 20 | X | 2 | 5 | x | 5 | x |
| E | 6 | 6 | 6 | 6 | 6 | 3 | 3 | 3 | 3 | 3 |
| F | 10 | 10 | 10 | 10 | 10 | 8 | 8 | 8 | 8 | 8 |
| G | 6 | 6 | 6 | 6 | 6 | 2 | 2 | 2 | 2 | 2 |
| H | 0.5 | 0.5 | 0.5 | 0.5 | 0.5 | x | X | X | X | x |
| I | 18.5 | 2.5 | 22.5 | 7.5 | 27.5 | 3 | 0 | 5 | 2 | 7 |
| No. of | 10- | 10- | 24- | 19- | 22- | 11- | 10- | 19- | 20- | 25- |
| Inversions | 11 | 11 | 25 | 20 | 23 | 12 | 11 | 20 | 21 | 26 |

A: Flonicamid, B: Fipronil, C: BC-700, D: Ammonium Sulfate, E: Ufoxane 3A, F: Sodium Lignosulfonate, G: Supragil WP, H: SAG 1572, I: Kaolin.

Number of inversions required to achieve complete dispersion of the granules was determined by the following procedure: A graduated cylinder of 250 ml was taken and 2 gm sample was added to the cylinder. It was allowed to soak for 2 min. The graduated cylinder was then closed by putting stopper and tilted to 180 ° C. and brought back to the original position in 2 seconds.

It was observed that the compositions comprising disintegration system (i.e. both ammonium sulfate and BC-700) found to have good disintegration profile as the dispersion is achieved in approx. 10-12 inversions and is highly suitable for end use. The composition according to the present invention works better at ratio ranging of ammonium sulfate and BC-700 from 1:1 to 1:4. The compositions of Example 3, 4, 5, 8, 9 & 10 which does not have disintegration system according to the present invention failed to give desired dispersion even in 19-26 inversions and hence found to be unsuitable.

Similarly, compositions (Examples 11-15) were prepared by incorporating two agrochemically active ingredients, viz. fipronil (hydrophobic agrochemical active ingredient) and flonicamid (hydrophilic agrochemical active ingredient) according to the present invention and tested for stability. The samples were prepared using varied quantities of the active ingredients and other ingredients as listed in the below table (Table 2). The samples were prepared as per the process given in Example 1. The samples were tested for dispersibility by observing the number of inversions required to achieve complete dispersion of active ingredients.

TABLE 2

| Ingredients | Examples | | | | |
|---|---|---|---|---|---|
| Number | 11 | 12 | 13 | 14 | 15 |
| Fipronil | 16.05 | 16.05 | 16.05 | 16.05 | 16.05 |
| Flonicamid | 16 | 16 | 16 | 16 | 16 |
| BC-700 | 2 | 2 | 2 | 0 | 7 |
| Ammonium sulfate | 7 | 2 | 0 | 7 | 2 |
| Ufoxane 3A | 6 | 6 | 6 | 6 | 6 |
| Sodium Lignosulphonate | 10 | 10 | 10 | 10 | 10 |
| Supragil WP | 6 | 6 | 6 | 6 | 6 |
| Sag-1572 | 0.5 | 0.5 | 0.5 | 0.5 | 0.5 |
| Kaolin | 36.45 | 41.45 | 43.45 | 38.45 | 41.45 |
| No. of Inversions | 11-13 | 13-15 | 25-30 | 20-25 | 20-25 |

Number of inversions required to achieve complete dispersion of the granules was determined by the following procedure: A graduated cylinder of 250 ml was taken and 2 gm sample was added to the cylinder. It was allowed to soak for 2 min. The graduated cylinder was then closed by putting stopper and tilted to 180 ° C. and brought back to the original position in 2 seconds.

It was observed that the compositions comprising disintegration system (i.e. both ammonium sulfate and BC-700) found to have good disintegration profile as the dispersion is achieved in approx. 11-15 inversions and is highly suitable for end use. The composition according to the present invention works better at both ratio ranging of ammonium sulfate and BC-700 from 1:1 to 1:4. The compositions of Example 13, 14 & 15 devoid of disintegration system according to the present invention failed to give desired dispersion even in 19-26 inversions.

### EXAMPLE 21

Test for Suspensibility and Stability of the Active Ingredient The WDG compositions of Example-1 and Example-6 prepared according to the present invention were investigated for suspensibility, degradation of active ingredient as well as its effect on stability of the composition. The stability study was conducted for zero days, 14 days AHS (Accelerated Heat Stability) at 54±2° C. and for 30 months RT (Real Time). Parameters such as suspensibility, wet sieve analysis and degradation of active ingredients were tested for 0, 14 and 30 months respectively. The results are summarized in Table 3.

TABLE 3

| | Example 1 | | | Example 6 | | |
|---|---|---|---|---|---|---|
| Physico/chemical | 0 | 14 | 30 | 0 | 14 | 30 |
| property | days | days | months | days | days | months |
| % degradation | NA | NA | NA | 0.0 | 0.14 | 0.11 |
| Fipronil | | | | | | |
| % degradation | 0.0 | 0.2 | 0.16 | NA | NA | NA |
| Flonicamid | | | | | | |
| No. of Inversions | 11-13 | 12-14 | 11-13 | 12-14 | 14-15 | 12-14 |
| Suspensibility | 91.30 | 90.60 | 90.80 | 83.20 | 81.90 | 82.80 |

As clear from Table 3, degradation of active flonicamid and active fipronil in respective WDG compositions was not observed when kept for ambient (at room temperature for 0 days), AHS (at 54±2° C. for 14 days) and RT (for 30 months). There was no significant change in the suspensibility of the composition. The composition according to the present invention remain stable according to the physico-chemical parameters. This signifies that the WDG compositions of flonicamid and WDG compositions of fipronil prepared using disintegration system not only possess excellent stability of the active ingredients but also retains the dispersibility and hence the availability of the active ingredients for the intended use. The compositions of Example 1 and Example 6 found to be stable in 30 months real time study which confronts to 2 years shelf life of the compositions.

Similarly, the WDG compositions of Example 11 and Example 12 prepared according to the present invention were investigated for suspensibility, degradation of active ingredient as well as its effect on stability of the composition. The stability study was conducted for ambient (zero days), AHS (14 days) and RT (12 months). Parameters such as suspensibility, wet sieve analysis and degradation of active ingredients were tested for 0 days, 14 days and 12 months respectively. The results are summarized in Table 4.

TABLE 4

| | Example 11 | | | Example 12 | | |
|---|---|---|---|---|---|---|
| Physico/chemical | 0 | 14 | 12 | 0 | 14 | 12 |
| property | days | days | months | days | days | months |
| % degradation | 0 | 0.1 | 0.065 | 0 | 0.14 | 0.14 |
| Fipronil | | | | | | |
| % degradation | 0 | 0.12 | 0.074 | 0 | 0.18 | 0.18 |
| Flonicamid | | | | | | |
| No. of Inversions | 11-13 | 12-14 | 11-13 | 13-15 | 14-15 | 12-14 |
| Suspensibility | 86.20 | 85.80 | 86.12 | 85.40 | 85.20 | 85.32 |

Thus, it can be seen from above table 4 that degradation of active compounds, fipronil and flonicamid in WDG compositions was not observed when kept even at of 54±2° C. for 14 days. Also, the compositions of Example 11 and Example 12 found to remain quite stable with negligible degradation when kept for real time stability for 12 months. There was no significant change in the suspensibility of the composition.

This signifies that the WDG composition of fipronil and flonicamid so obtained has not only excellent stability of the active ingredients but also retains the dispersibility and hence the availability of the active ingredients for the intended use.

In conclusion it is demonstrated that the compositions according to the present invention remain stable according to the physico-chemical parameters. The combination of actives and disintegration system in the composition of the present invention leads to stable WDG composition which does not undergo any chemical and physical changes on storage and is also easy to handle for further use.

1. A stable insecticide composition comprising:
at least one agrochemical active ingredient, and
a disintegration system,
wherein said disintegration system comprises a polymer matrix and an inorganic salt.

2. The stable insecticide composition as claimed in claim 1, wherein said agrochemical active ingredient is selected from hydrophilic agrochemical active ingredients and hydrophobic agrochemical active ingredients.

3. The stable insecticide composition as claimed in claim 2, wherein said hydrophilic agrochemical active ingredient is selected from the group consisting of pyridine organic compounds, triazines, organophosphorous compounds, neocotinoids, phthalimides, their derivatives and salts thereof.

4. The stable insecticide composition as claimed in claim 3, wherein said hydrophilic agrochemical active ingredient is selected from the group consisting of flonicamid, pymetrozine, acephate, glufosinate, acetamiprid, captan, and folpet.

5. The stable insecticide composition as claimed in claim 2, wherein said hydrophobic agrochemical active ingredient is selected from the group consisting of phenyl pyrazole compound, diamides, triazinone, pyrethroids, oxadiazines, thioureas, their derivatives and salts thereof.

6. The stable insecticide composition as claimed in claim 5, wherein said hydrophobic agrochemical active ingredients is selected from the group consisting of fipronil, flubendiamide, metribuzin, indoxacarb, diafenthiuron, and bifenthrin.

7. The stable insecticide composition as claimed in claim 1, wherein said polymer matrix is selected from the group consisting of polyureas, polyvinyl chloride, polyurethanes, polyamides, pyrrolidine, acrylic polymers, polyisocyanate-cyclic alkylenes, polyamines, polyimines, polycarboxylic acids, naturally occurring polymers, their derivatives, mixtures, and salts thereof.

8. The stable insecticide composition as claimed in claim 1, wherein said polymer matrix of said disintegration system is a urea-formaldehyde copolymer.

9. The stable insecticide composition as claimed in claim 1, wherein said inorganic salt is selected from the group consisting of ammonium sulfate, sodium sulfate, ammonium bicarbonate, sodium bicarbonate, magnesium sulfate, hydrogen carbonate, sodium chloride, sodium citrate, ammonium citrate, sodium acetate bentonite, aluminium chloride, citric acid, succinic acid, and mixtures thereof.

10. The stable insecticide composition as claimed in claim 1, wherein said inorganic salt is ammonium sulfate.

11. The stable insecticide composition as claimed in claim 1. wherein said disintegration system comprises the polymer matrix and inorganic salt in a ratio from about 1:1 to about 1:4.

12. A stable insecticide composition comprising:
i. at least one hydrophilic agrochemical active ingredient,
ii. at least one hydrophobic agrochemical active ingredient, and
iii. a disintegration system; wherein said disintegration system comprises a polymer matrix and an inorganic salt.

13. The stable insecticide composition as claimed in claim 13, wherein said hydrophilic agrochemical active ingredient is selected from the group consisting of flonicamid, pymetrozine, acephate, glufosinate, acetamiprid, captan, and folpet, and said hydrophobic agrochemical active ingredients is selected from the group consisting of fipronil, flubendiamide, metribuzin, indoxacarb, diafenthiuron, and bifenthrin.

14. The stable insecticide composition as claimed in claim 13, wherein said disintegration system comprises the polymer matrix and inorganic salt in a ratio from about 1:1 to about 1:4.

15. The stable insecticide composition of claim 13 comprising:
i. flonicamid,
ii. fipronil, and

16. The stable insecticide composition of claim 13 comprising:
i. diafenthiuron,
ii. fipronil.

17. The stable insecticide composition of claim 13 comprising:
i. pymetrozine, and
ii. fipronil.

18. The composition as claimed in claim 15, wherein said disintegration system comprises the polymer matrix and inorganic salt in a ratio from about 1:1 to about 1:4.

19. The composition as claimed in claim 1, wherein said composition is in the form of water dispersible granular formulation.

20. The composition of claim 19, comprising as the at least one agrochemical active ingredient:
at least one hydrophilic agrochemical active ingredients selected from the group consisting of pyridine organic compound and organophosphorous compounds;
at least one hydrophobic agrochemical active ingredient selected from the group consisting of phenyl pyrazole compound, diamide, triazine, pyrethroids, oxadiazine and thiourea class of compounds.

21. A process of preparing the stable insecticide composition of claim 1, wherein said process comprising steps of:
i. blending a mixture of the one or more agrochemically active ingredients, the disintegration system comprising the polymer matrix and the inorganic salt, salt, to obtain a blend;
ii. grinding the blend to obtain a homogeneous mixture; and
iii. preparing a dough from the homogenous mixture and performing granulation to obtain a granular composition.

22. A method of controlling insects comprising applying to pests or to their locus,
an effective amount of the stable insecticide composition of claim 1.
